(19) United States
(12) Patent Application Publication
(10) Pub. No.: US 2013/0216008 A1
(43) Pub. Date: Aug. 22, 2013

(54) Method and Associated Apparatus for Determining Signal Timing of Wireless Network Signal

(71) Applicant: MStar Semiconductor, Inc., (US)

(72) Inventors: Shao-Ping Hung, Taipei City (TW); Tien-Hsin Ho, Zhubei City (TW); Tai-Lai Tung, Zhubei City (TW); Ching-Hsiang Chuang, New Taipei City (TW)

(73) Assignee: MSTAR SEMICONDUCTOR, INC., Hsinchu Hsien (TW)

(21) Appl. No.: 13/771,363

(22) Filed: Feb. 20, 2013

(30) Foreign Application Priority Data
Feb. 21, 2012 (TW) 101105700

(51) Int. Cl. H04B 7/04

(52) U.S. Cl. CPC H04B 7/0413
USPC 375/343

(57) ABSTRACT

A method for determining signal timing of a wireless network signal is provided. The method includes: performing match-filtering on the wireless network signal transmitted by one or multiple antennas to provide a match value distribution, performing moving averaging on the match value distribution to provide an accumulation distribution, searching a peak of the accumulation distribution to provide a central timing according to a timing at which the peak occurs, and determining the signal timing (e.g., a symbol boundary) of the wireless network signal according to the central timing.

This application claims the benefit of Taiwan application Serial No. 101105700, filed Feb. 21, 2012, the subject matter of which is incorporated herein by reference.

### BACKGROUND OF THE INVENTION

1. Field of the Invention

The invention relates in general to a method and associated apparatus for determining signal timing of a wireless network signal, and more particularly to method and associated apparatus for determining a symbol boundary in a wireless network signal in multi-antenna transmission.

2. Description of the Related Art

A wireless network, which performs exchange, interconnection, communication and/or broadcasting of packet, data, message, command, audio and video streams by network signals via wireless transmission, is one of the most important network techniques in the modern information society. Among the various wireless network techniques, the multi-input multi-out (MIMO) technique is a focus of on-going research and development. Reasons contributing to such importance on the MIMO technique are that, without additional bandwidth, the MIMO technique is capable of increasing a network capacity and a data transmission rate, reducing a bit error rate, strengthening interference resistance, improving directivity through beamforming and/or reinforcing resistance against channel attenuation. For example, a wireless local area network based on the IEEE 802.11n specification has included the MIMO technique. In a MIMO wireless network, one transmitter may be provided with multiple antennas each sending corresponding single-antenna signals. Network signals received at a receiver are synthesized from the single-antenna signals. Similarly, one receiver may also be provided with one or multiple antennas to receive the network signals transmitted from the transmitter.

When a transmitter transmits a wireless network signal, according to predetermined signal timing, the wireless network signal is divided into different periods, e.g., time slots, symbols and signal frames. The periods carry respective waveforms, messages and/or data. For example, in an Orthogonal Frequency Division Multiplexing (OFDM) wireless network, a wireless network signal is divided into different OFDM symbols. In each OFDM symbol, digital data is carried by multiple orthogonal frequency sub-carriers. The signal timing of the wireless network signal is then reconstructed after the receiver receives the wireless network signal, so as to correctly parse the message or data carried in the wireless network signal in synchronization with the signal timing. For example, in an OFDM wireless network, the signal timing reflects a symbol boundary of an OFDM symbol. Therefore, a receiver needs to identify the symbol boundary in order to correctly parse the digital data carried in each OFDM symbol.

To allow the receiver to reconstruct the signal timing of the wireless network, the transmitter adds a sequencing signal for synchronization in the wireless network signal. Content (e.g., waveform and/spectrum) of the sequencing signal is predetermined according to a corresponding wireless network specification. Therefore, for the receiver, the content of the sequencing signal is known. As the receiver identifies the sequencing signal in the wireless network signal, boundaries of various periods following the sequencing signal can be determined according to the signal timing in the wireless network signal to parse data and/or messages in the various periods following the sequencing signal. For example, in an OFDM wireless network signal, a short preamble in a preamble of a packet may be regarded as a sequencing signal. A sequence of the short preamble contains multiple short preambles having repeated content for timing synchronization.

When a transmitter transmits wireless network signals via one or multiple antennas, the antenna transmits respective single-antenna wireless signals. A network signal received by the receiver is synthesized from the single-antenna wireless signals. The single-antenna wireless signals of the antennas contain respective sequencing signals. To prevent unexpected beam-forming, the transmitter introduces a cyclic shift delay between sequencing signals of different antennas. However, since the wireless network signal is mixed with the sequencing signals of different antennas, a conventional receiver is incapable of stably determining the signal timing as the receiver identifies the sequencing signals in the wireless network signal. For example, at a particular instant, assuming a single-antenna wireless signal of a first antenna is stronger, a conventional receiver determines a first signal timing according to the sequencing signal of the first antenna. At another instant, assuming a single-antenna wireless signal of a second antenna is stronger, the conventional receiver then determines a second signal timing according to the sequencing signal of the second antenna. Due to the cyclic shift delay between the sequencing signals of the two antennas, the obtained first signal timing may differ from the second signal timing. In other words, the signal timing at the receiver is not robust enough to resist against changes in signal strength of different antennas.

### SUMMARY OF THE INVENTION

In an application where a transmitter has only a single antenna, a receiver can identify a sequencing signal in a wireless network signal through a match-filtering technique. For different time points, the receiver respectively sets a matched range, and provides a corresponding match value for each of the time points according to an accumulated product of the wireless network signal and a predetermined signal in the matched range corresponding to each of the time points. By collecting the match values at different time points n, a match value distribution is formed. A peak of the match value distribution is searched to identify a timing at which the sequencing signal in the wireless network signal occurs to further determine the signal timing of the wireless network signal. However, in the event that the wireless network signal is synthesized from wireless signals of multiple antennas, multiple local peaks correspondingly occur in the match value distribution, such that a stable signal timing cannot be provided according to the peak of the match value distribution.

The present invention is directed to an improved match-filtering technique for stably determining a signal timing in an application having one or multiple antennas.

It is an object of the present invention to provide a method for determining a signal timing of a wireless network signal. The method is applied to a receiver of a wireless network. The method includes: performing match-filtering on the wireless network signal to provide a match value distribution, performing moving averaging on the match value distribution to provide an accumulation distribution, searching a peak of the accumulation distribution to provide a central timing according to a timing at which the peak occurs, and determining the signal timing (e.g., symbol boundary) of the wireless network signal according to the central timing.

In one embodiment, when providing the central timing, the accumulation distribution is compared with a threshold, and an upper timing limit and a lower timing limit are provided according to an intersection time point of the accumulation distribution and the threshold. In one embodiment, the threshold is set according to a product of the value of the peak of the accumulation distribution and a threshold ratio.

In one embodiment, when performing the moving averaging, a corresponding accumulation range is respectively set for different time points, and the accumulation value is accumulated in the accumulation ranges corresponding to the time points to provide a corresponding accumulation value for each of the time points.

It is another object of the present invention to provide an apparatus for determining a signal timing of a wireless network signal. The apparatus is applied to a receiver of a wireless network. The apparatus includes a matched filter module, an accumulation value module, a peak value and a timing module. The matched filter module performs matching filtering on the wireless network signal to provide a match value distribution. The accumulation value module performs moving averaging on the match value distribution to provide an accumulation distribution. The peak module provides a central timing according to a timing at which the peak occurs in the accumulation distribution. The timing module determines the signal timing of the wireless network signal according to the central timing.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 shows a matched filter according to one embodiment.

FIG. 2 shows results of match-filtering corresponding to network signals transmitted by a single transmitting antenna and multiple transmitting antennas.

FIG. 3 is a moving averager according to one embodiment of the present invention.

FIG. 4 is an operation result of the moving averager in FIG. 3.

FIG. 5 is a schematic diagram of estimating a central timing by use of a moving averager result according to one embodiment of the present invention.

FIG. 6 is a schematic diagram of an apparatus according to one embodiment of the present invention.

### DETAILED DESCRIPTION OF THE INVENTION

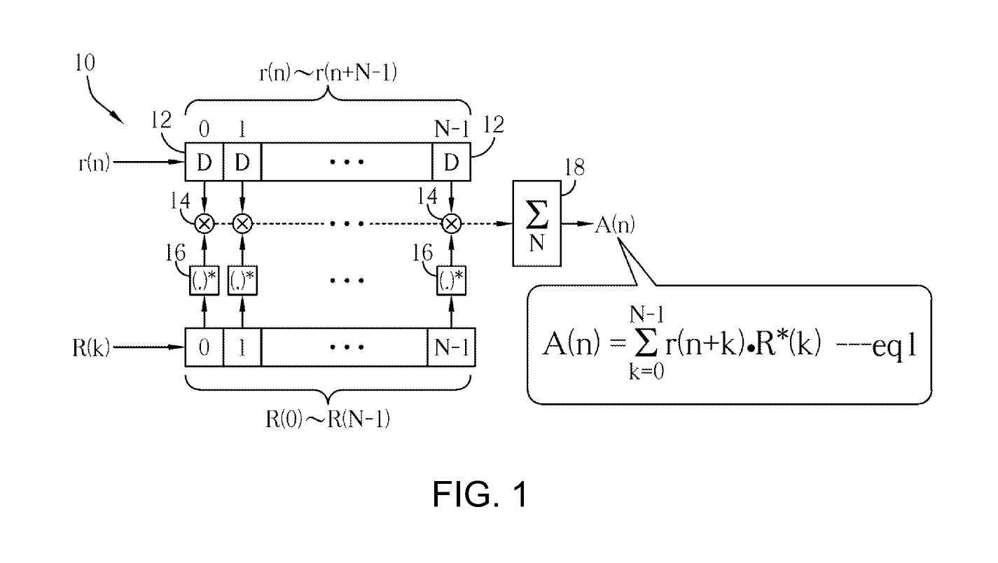

FIG. 1 shows a matched filter 10 according to one embodiment. A matched filter 10 performs match-filtering on a network signal r(n), which may be a wireless network signal received by a receiver of a wireless network. For example, when the receiver receives a wireless network signal including a mixed, band-pass and/or low-pass filter signal, the received wireless network signal is down-converted to an intermediate-frequency (IF) or baseband signal. The IF signal or baseband signal is then sampled/digitized to obtain a signal as the network signal r(n). The network signal r(n) may be a complex signal having a real part and an imaginary part, which respectively correspond to an in-phase part and a quadrature-phase part of the wireless network signal.

The matched filter 10 includes a plurality of retarders 12, multipliers 14, conjugate complex calculators 16 and an accumulator 18 for implementing match-filtering. A match range (e.g., 0 to (N−1)) is respectively set for different time points n, and a product of the signal r(n) and a conjugate complex R*(k) of a predetermined signal R(k) in the match ranges corresponding to the time points n is accumulated to provide a corresponding match value A(n) for each of the time points n. Referring to Equation eq1, the matched filter 10 respectively multiplies N number of network signal values r(n) to r(n+N−1) after a particular time point n by conjugate complexes R*(0) to R(N−1) of the N number of predetermined signal values R(0) to R(N−1), and accumulates the products to provide a result serving as the match value A(n). By collecting the corresponding match value A(n) of different time points n, a match value distribution is formed.

In the match-filtering performed by the matched filter 10, the predetermined signal R(n) is a sequencing signal with known content. In other words, a purpose of the match-filtering performed by the matched filter 10 is to identify the sequencing signal in the network signal r(n).

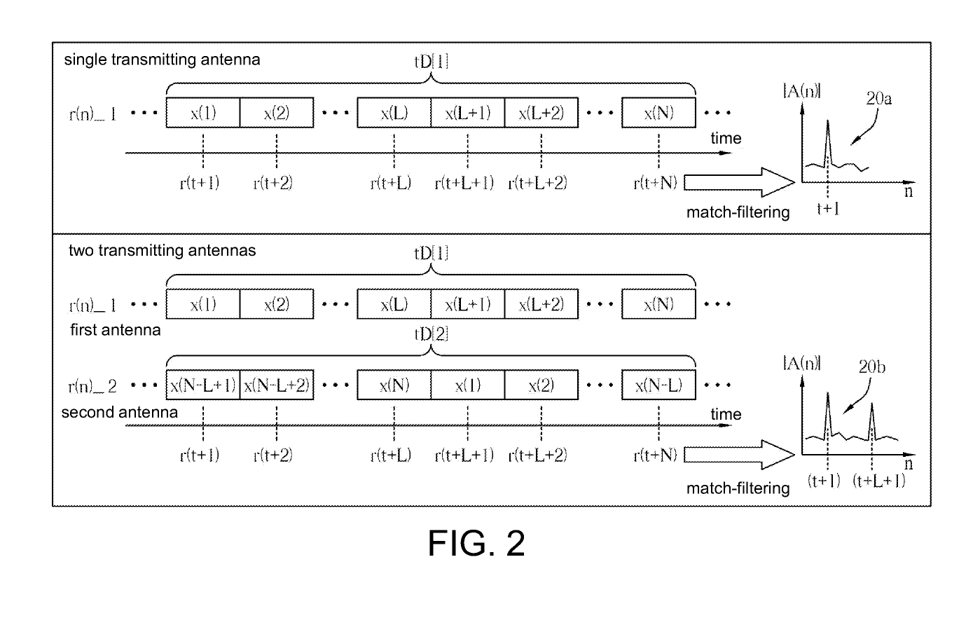

FIG. 2 shows a result of match-filtering on the network signal r(n) for different numbers of antennas. When a transmitter transmits wireless network signals with a single antenna, the single antenna transmits a single-antenna signal r(n)_1, and the network signal r(n) received by the receiver is formed by the single-antenna wireless signal r(n)_1. The single-antenna wireless signal r(n)_1 contains a plurality of sequencing signals tD[1] to form the sequencing signal. For example, in an OFDM wireless network, the sequencing symbol tD[1] may be a short preamble (also referred to as a short training symbol). Referring to FIG. 2, each of the sequencing symbols tD[1] includes N number of sample values x(1) to xx(N). When being received by the receiver, the signal values x(1) to x(N) respectively correspond to network signals values r(t+1) to r(t+N) of time points (t+1) to (t+N). Since the content of the sequencing symbols are predetermined according to a corresponding wireless network specification, the sample values x(1) to x(N) are fixed and known. When the receiver performs the match-filtering of FIG. 1, the predetermined signal values R(0) to R(N−1) in Equation eq1 are set according to the sample values x(1) to x(N), and a match value distribution 20a in FIG. 2 show the result of the match-filtering of the network signal r(n). A peak occurs in the match value distribution 20a of the sequencing signal tD[1]. In other words, the presence of the peak indicates that the match-filtering has already identified the sequencing symbol from the network signal r(n), with the timing of the peak corresponding to the timing of the sequencing symbol. According to the timing of the sequencing symbol, the receiver is allowed to reconstruct the signal timing dividing the periods of the network signal r(n), e.g., boundaries of time slots, symbols, signal frames, and/or OFDM symbols.

Moreover, when the transmitter is provided with first and second antennas and respectively transmits single-antenna signals r(n)_1 and r(n)_2 via the first and second antennas, the network signal r(n) received by the receiver is synthesized from the two single-antenna signals r(n)_1 and r(n)_2. For example, r(n)=h1*r(n)_1+h2*r(n)_2, wherein h1 and h2 are synthesis weightings. Based on differences between distances, directions, noise and channel attenuation between the two antennas and the receiver, the weightings h1 and h2 may be different and may have random values. The single-antenna signals r(n)_1 and r(n)_2 respectively include a plurality of repeated sequencing symbols tD[1] and tD[2]. The sequencing symbol tD[1] includes N number of sample values x(1) to x(N). In contrast, due to the cyclic shift delay introduced into the single-antenna wireless signal r(n)_2 of the second antenna at the transmitter, for the sequencing symbol tD[2], first L number of sample values are respectively x(N-L+1) to x(N), and subsequent (N−L) number f sample values are respectively sample values x(1) to x(N−L). In other words, the sample values in the sequencing symbol tD[2] are obtained by cyclically shifting the sample values x(1) to x(N) by the number L, where the number L corresponds to a shift period of the cyclic shift delay.

Since the network signal r(n) is synthesized from the single-antenna wireless signals r(n)_1 and r(n)_2, the L number of network signal values r(t+1) to r(t+L) at the time points (t+1) to (t+L) are respectively synthesized from the sample values x(1) to x(L) and sample values x(N-L+1) to x(N), that is, the network signal value r(t+n)=h1*x(n)+h2*x(N-L+n), wherein n=1. In the subsequent time points (t+L+1) to (t+N), the subsequent (N−L) number of network signal values r(t+L+1) to r(t+N) are respectively synthesized from the sample values x(L+1) to x(N) and the sample values x(1) to x(N−L), that is, the network signal value r(t+n)=r(t+n)=h1*x(n)+h2*x(n-L), where n=(L+1) to N.

However, when the receiver performs the match-filtering of FIG. 1, the predetermined signal values R(0) to R(N−1) in Equation eq1 are still set by the sample values x(1) to x(N). A match value distribution 20b in FIG. 2 shows a result of the match-filtering of the network signal r(n) of the two antennas. The match value distribution 20a shows two local peaks for the sequencing symbols tD[1] and tD[2] corresponding to the time points (t+1) and (t+N). A time difference between the two local peaks corresponds to the number L of the cyclic shift. The values of the two local peaks are affected by the weightings h1 and h2, which randomly change according to noises and/or random channel attenuation, such that a relation between the values of the two local peaks is also randomly changed. That is, the value of the former local peak may be greater or smaller than the value of the latter local peak. Therefore, to adopt the approach of the situation of a single antenna, the signal timing reconstructed from the higher peak of the two local peaks is not only random but also unstable.

Situations of more antennas may be deduced from the situation of two antennas. When the transmitter transmits M number of single-antenna wireless signals by M number of antennas (M being greater than 1), in a sequencing symbol tD[m] of an m^{th} (m is any number of 2 to M) single-antenna wireless signal, the first (m−1)*L number of sample values in N number of sample values are cyclic shifted sample values x(N−(m−1)*L+1) to x(N), and the subsequent (N−(m−1)*L) number of sample values in the N number of sample values are sample values x(1) to x(N−(m−1)*L). Since the network signal r(n) received by the receiver is synthesized from the M number of single-antenna wireless signals, for the sequencing symbols tD[1] to tD[M] at the time points (t+1) to (t+N), M number of local peaks occur in the match value distribution obtained from the match-filtering of the network signal r(n). Similarly, a relation between the values of the M number of local peaks is also random, and a stable signal timing cannot be reconstructed according to the values of the local peaks.

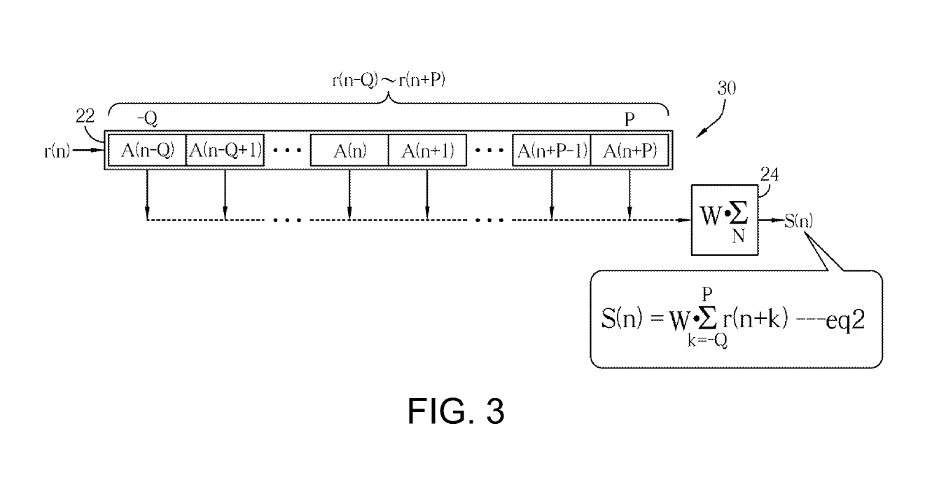

To provide a stable signal timing by utilizing the M number of local peaks formed in the match value distribution of the M number of antennas, the match value distribution is further averaged to integrate the M number of local peaks. FIG. 3 shows a moving averager 30 for moving averaging a match value distribution according to one embodiment the present invention. The moving averager 30 includes a register 22 and an accumulator 24. Referring to Equation eq2, the moving averager 30 sets a corresponding accumulation range (n−Q) to (n+P) for a particular time point n, and accumulates match values A(n−Q) to A(n+P) in the accumulation ranges (n−Q) to (n+P) to provide an accumulation value S(n) corresponding to the time point n. Wherein, the gain W may be a constant, e.g., 1 or 1/(P+Q). For example, the numbers P and Q are defined according to the numbers M and L, e.g., a sum (P+Q) approximates or is slightly larger than the number (M−1)*L. The numbers P and Q may be the same or different, with either one being equal to 0. For the time points n, the register 22 temporarily stores the match values A(n−Q) to A(n+P) of time points (n−Q) to (n+P). The accumulator 24 then accumulates the match values A(n−Q) to A(n+P) to obtain the corresponding accumulation value S(n). By collecting accumulation values S(n) corresponding to different time points n, an accumulation distribution is formed.

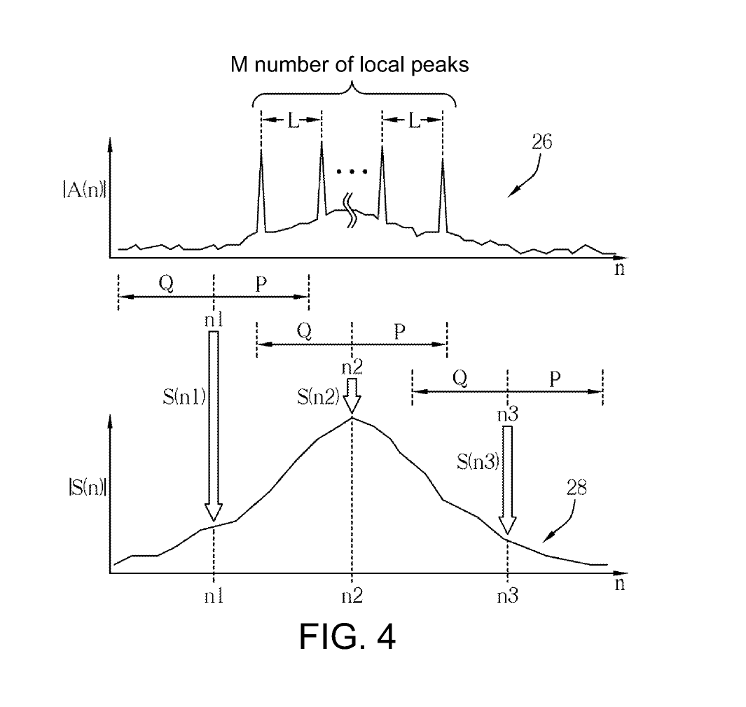

FIG. 4 shows a schematic diagram of a corresponding accumulation distribution 28 obtained from a match value distribution 26 according to one embodiment of the present invention. At different time points (n1−Q) to (n1+P), (n2−Q) to (n2+P) and (n3−Q) to (n3+P), match values A(n1−Q) to A(n1+P), A(n2−Q) to A(n2+P) and A(n3−Q) to A(n3+P) are accumulated to obtain accumulation values A(n1), A(n2) and A(n3) corresponding to the time points n1, n2 and n3. Referring to FIG. 4, after performing the moving averaging of FIG. 3, only one peak occurs in the accumulation distribution 28 obtained after the moving averaging even if there are M number (M being greater than or equal to 1) of local peaks in the match value distribution 26.

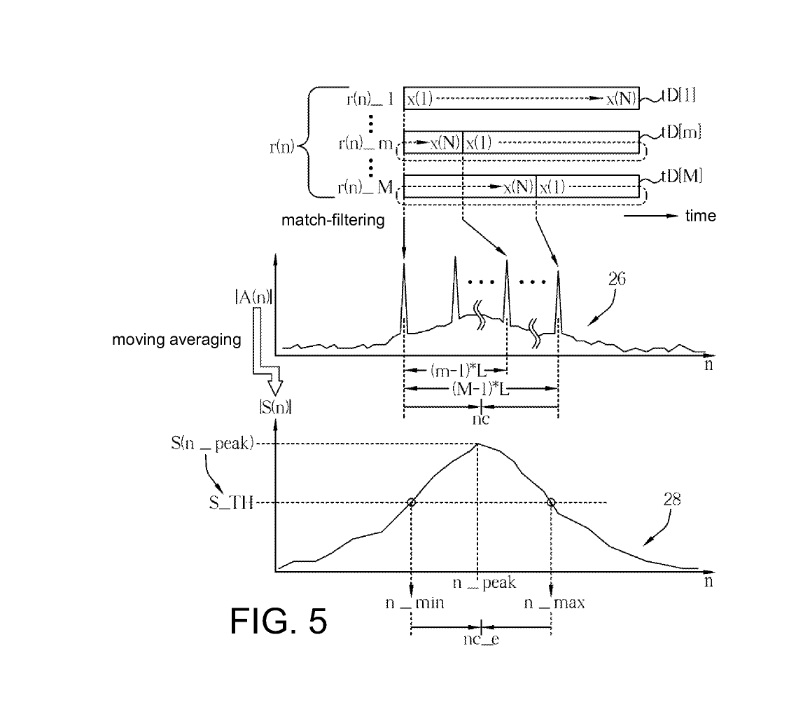

Reference is made to FIGS. 1 to 4 as well as FIG. 5 in connection with the description below. FIG. 5 shows a schematic diagram of determining a signal timing for a received signal r(n) according to the accumulation distribution 28 according to one embodiment of the present invention. As discussed with reference to FIG. 2, the received signal r(n) may be synthesized from single-antenna signals r(n)_1, . . . , r(n)_m to r(n)_M of M number of antennas. Due to mutual cyclic shift delays, the sequencing symbols tD[1] to tD[M] in the single-antenna signals r(n)_1 to r(n)_M form M number of local peaks in the match value distribution 26. These M number of local peaks respectively correspond to initiation positions of the cyclic shifts of the sequencing symbols tD[1] to tD[M], i.e., initiation timings of the sample values x(1) in the sequencing symbols tD[1] to tD[M]. Therefore, given that a central time point nc between the first and the M^{th} local peaks is identified, boundaries (e.g., initiation and end time points) of the sequencing symbols can be determined to further determine the signal timing of the received signal r(n). A principle of the present invention is to estimate the central time point nc by use of the accumulation distribution 28.

As shown in FIG. 5, in one embodiment of the present invention, a threshold S_TH is set for the accumulation distribution 28. The accumulation distribution 28 is compared with the threshold S_TH, and an upper timing limit and a lower timing limit are provided according to an intersection time point of the accumulation distribution 28 and the threshold S_TH. For example, the upper timing limit and the lower timing limit are time points n_max and n_min. According to the upper timing limit and the lower timing limit, a central time point nc_e (regarded as a central timing) is obtained, and the central time point nc_e may serve as an estimated value of the central time point nc. For example, the central time point nc_e is an average of the upper timing limit and the lower timing limit: nc_e=(n_min+n_max)/2. The timings of the sequencing symbols may be determined based on the central time point nc_e and the known value of the number L to further determine the signal timing of the network signal r(n), thereby achieving an object of the present invention.

In one embodiment of the present invention, the threshold S_TH is determined according to the peak value (i.e., the accumulation value S(n_peak)) of the accumulation distribution 28. For example, the threshold value S_TH is set according to a product of the peak value S(n_peak) and a threshold ratio R, e.g., S_TH=R*S(n_peak), where the threshold ratio R may equal to a predetermined constant.

In another embodiment of the present invention, the time point n_peak at which the peak occurs is utilized as the estimated value of the central time point nc to further determine the signal timing of the network signal r(n), thereby achieving the object of the present invention.

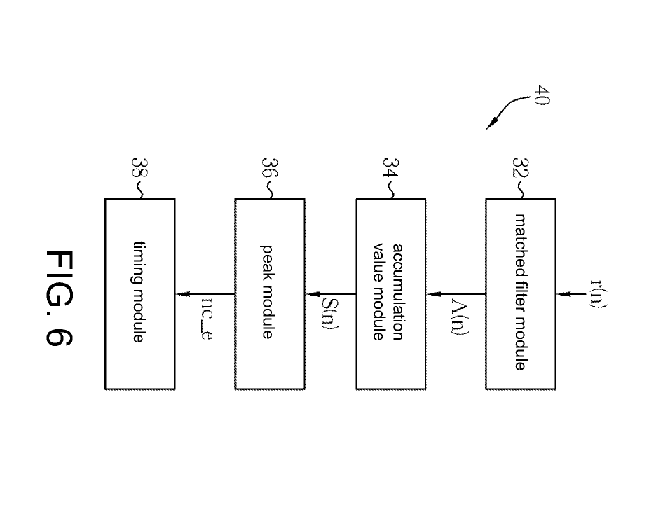

FIG. 6 shows an apparatus 40 according to one embodiment of the present invention. The apparatus 40 is disposed at a wireless network receiver (not shown) to determine a signal timing of a network signal r(n) received by the receiver. The apparatus 40 includes a matched filter module 32, an accumulation value module 34, a peak module 36 and a timing module 38. The matched filter module 32, the accumulation value module 34, the peak module 36 and the timing module 38 are connected in series. The matched filter module 32, implemented as the matched filter 10 in FIG. 1, performs match-filtering on the network signal r(n) to provide a time domain distribution of a match value A(n). The accumulation value module 34, implemented as the moving averager 30 in FIG. 3, performs moving averaging on the match value A(n) to provide an accumulation value S(n) and a time domain distribution of the accumulation value S(n). Based on the principle in FIG. 5, the peak module 36 provides a central time point nc_e as a central timing according to a timing at which a peak occurs in the accumulation distribution. The timing module 38 then determines the signal timing of the network signal r(n) according to the central timing. The apparatus 40 may be implemented by hardware, software and/or firmware. For example, the matched filter module 32 and the accumulation value module 34 may be implemented by hardware logic circuits.

In conclusion, in an application of multiple transmission antennas, due to the fact that match-filtering is affected by peak values of a match value distribution, a signal timing cannot be stably provided for a network signal received by a wireless network receiver. In contrast, in the present invention, multiple peaks of a match value distribution are integrated into one peak of an accumulated value distribution to provide a stable basis for the signal timing. Therefore, reconstruction of the signal timing is immune from random changes in local peaks of a matched filter so that the wireless network receiver is allowed to correctly parse the wireless network signal received.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for determining timing of a wireless network signal, comprising:
performing match-filtering on the wireless network signal to provide a match value distribution;
performing moving averaging on the match value distribution to provide an accumulation distribution;
providing a central timing according to a timing at which a peak occurs in the accumulation distribution; and
determining the timing of the wireless network signal according to the central timing.

2. The method according to claim 1, wherein the step of providing the central timing comprises:
setting a threshold;
comparing the accumulation distribution with the threshold, and providing an upper timing limit and a lower timing limit according to an intersection time point of the accumulation distribution and the threshold; and
setting the central timing according to the upper timing limit and the lower timing limit.

3. The method according to claim 2, wherein the step of providing the central timing further comprises:
setting the central timing according to an average of the upper timing limit and the lower timing limit.

4. The method according to claim 2, wherein the step of setting the threshold sets the threshold according to a value of the peak.

5. The method according to claim 2, wherein the step of setting the threshold sets the threshold according to a product of a value of the peak and a threshold ratio.

6. The method according to claim 1, wherein the step of performing the match-filtering comprises:
setting a match range for different time points, respectively, and providing a corresponding match value for each of the time points according to an accumulated product of the wireless network signal and a predetermined signal in the match range corresponding to each of the time points.

7. The method according to claim 1, wherein the step of performing the moving averaging comprises:
setting a corresponding accumulation range for different time points, respectively, and providing a corresponding accumulation value for each of the time points by accumulating the match value in the match range corresponding to each of the time points.

8. The method according to claim 1, wherein the wireless network signal is synthesized from a plurality of single-antenna wireless signals respectively transmitted by a plurality of antennas; and a symbol boundary of the wireless network signal is determined according to the central timing and a number of the antennas at the step of determining the signal timing of the wireless network signal.

9. The method according to claim 1, wherein the wireless network signal is synthesized from a predetermined number of single-antenna wireless signals each comprising a corresponding sequencing signal, and between the sequencing signals corresponding to the different single-antenna wireless signals is a cyclic shift delay.

10. An apparatus for determining a signal timing of a wireless network signal, applied to a receiver of a wireless network, the apparatus comprising:
a matched filter module, for performing match-filtering on the wireless network signal to provide a match value distribution;
an accumulation module, for performing moving averaging on the match value distribution to provide an accumulation distribution;
a peak module, for providing a central timing according to a timing at which a peak occurs in the accumulation distribution; and
a timing module, for determining the signal timing of the wireless network signal according to the central timing.

11. The apparatus according to claim 10, wherein the peak module compares the accumulation distribution with the threshold, provides an upper timing limit and a lower timing limit according to an intersection time point of the accumulation distribution and the threshold, and sets the central timing according to the upper timing limit and the lower timing limit.

12. The apparatus according to claim 11, wherein the peak module sets the central timing according to an average of the upper timing limit and the lower timing limit.

13. The apparatus according to claim 11, wherein the peak module sets the threshold according to a value of the peak.

14. The apparatus according to claim 11, wherein the peak module sets the threshold according to a product of a value of the peak and a threshold ratio.

15. The apparatus according to claim 10, wherein the matched filter module sets a match range for different time points, respectively, and provides a corresponding match value for each of the time points according to an accumulated product of the wireless network signal and a predetermined signal in the match range corresponding to each of the time points.

16. The apparatus according to claim 10, wherein the moving averaging module sets a corresponding accumulation range for different time points, respectively, and provides a corresponding accumulation value for each of the time points by accumulating the match value in the match range corresponding to each of the time points.

17. The apparatus according to claim 10, wherein the wireless network signal is synthesized from a plurality of single-antenna wireless signals respectively transmitted by a plurality of antennas; and the timing module determines the signal timing of the wireless network signal according to the central timing determines a symbol boundary of the wireless network signal according to the central timing and a number of the antennas.

18. The apparatus according to claim 10, wherein the wireless network signal is synthesized from a predetermined number of single-antenna wireless signals each comprising a corresponding sequencing signal, and between the sequencing signals corresponding to the different single-antenna wireless signals is a cyclic shift delay.
